(19) United States
(12) Patent Application Publication
(10) Pub. No.: US 2023/0306351 A1
(43) Pub. Date: Sep. 28, 2023

(54) SECURELY COMPUTING SKILL LEVEL USING DATA ANONYMIZATION

(71) Applicant: Microsoft Technology Licensing, LLC, Redmond, WA (US)

(72) Inventors: Vita G. Markman, San Francisco, CA (US); Jose Eduardo Corona Espinoza, Seattle, WA (US); Xin Liu, San Jose, CA (US)

(21) Appl. No.: 17/705,071

(22) Filed: Mar. 25, 2022

(51) Int. Cl. G06Q 10/06; G06Q 10/10; G06K 9/62; G06F 21/62; G06F 11/34

(52) U.S. Cl. CPC G06Q 10/06398; G06Q 10/1053; G06K 9/6215; G06F 21/6254; G06F 11/3438

(57) ABSTRACT

Techniques for securely computing skill level of users of an online service using data anonymization to protect data privacy are disclosed herein. In some embodiments, a computer-implemented method comprises: performing a data anonymization process on a dataset, the data anonymization process comprising removing reference user identifications from the dataset; computing a combined skill-title association score for each title-skill pair in the dataset based on a title-skill association resume score and a title-skill similarity score of the title-skill pair; and computing a skill level value of a user in response to a determination that a profile of the user includes one of the title-skill pairs, the skill level value indicating a skill level in the skill and being computed using a duration of experience of the user in the job title and the combined skill-title association score; and using the skill level value in an application of the online service.

### TECHNICAL FIELD

The present application relates generally to securely computing skill level of users of an online service using data anonymization to protect data privacy.

### BACKGROUND

Online service providers, such as social networking services, e-commerce and marketplace services, photo sharing services, job hosting services, educational and learning services, and many others, typically require that each end-user register with the individual service to establish a user account. In most instances, a user account will include or be associated with a user profile—a digital representation of a person's identity. As such, a user profile may include a wide variety of information about the user, which may vary significantly depending upon the particular type and nature of the online service. By way of example, in the context of a social networking service, a user's profile may include information such as: first and last name, e-mail address, age, location of residence, a summary of the user's educational background, job history, and/or experiences, as well as individual skills possessed by the user. A user profile may include a combination of structured and unstructured data. For example, whereas a user's age may be stored in a specific data field as structured data, other profile information may be inferred from a free form text field such as a summary of a user's experiences. Furthermore, while some portions of a user profile, such as an e-mail address, may be mandatory—that is, the online service may require the user to provide such information in order to register and establish an account—other portions of a user profile may be optional.

In many instances, the quality of the experience a user has with a particular online service may vary significantly based on the extent to which the user has provided information to complete his or her user profile. Generally, the more complete a user profile is, the more satisfied the user is likely to be with various features and functions of the online service. By way of example, consider the extent to which a user has listed in his or her profile for a professional social networking service the skills possessed by the user. In the context of an online service, a variety of content-related and recommendation services utilize various aspects of a user's profile information—particularly skills—for targeting users to receive various content and for generating recommendations. For example, a content selection and ranking algorithm associated with a news feed, which may be referred to as a content feed, or simply a feed, may select and/or rank content items for presentation in the user's personalized content feed based on the extent to which the subject matter of a content item matches the perceived interests of the user. Here, the user's perceived interests may be based at least in part on the skills that he or she has listed in his or her profile. Similarly, a job-related search engine and/or recommendation service may select and/or rank job postings for presentation to a user based in part on skills listed in a profile of the user. Finally, a recommendation service for online courses may generate course recommendations for a user based at least in part on the skills that the user lists in his or her profile. Accordingly, the value of these services to the user can be significantly greater when the user has completed his or her profile by adding his or her skills.

However, online service providers do not provide a framework in which a user's skill level for a particular skill (e.g., how well the user knows the particular skill) is included in the user's profile or used by online service providers in the services they provide. For example, although a user's profile may list machine learning as a skill, online service providers do not have a way to accurately determine from this information what level of skill the user has in machine learning. As a result of this lack of data, online service providers fail to accurately consider and address important data in providing recommendations and other online content.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating functional components of an online service, in accordance with an example embodiment.

FIG. 2 a flowchart illustrating a method of securely computing skill level of users of an online service using data anonymization to protect data privacy, in accordance with an example embodiment.

FIG. 3 illustrates a graphical user interface (GUI) in which a user profile is displayed, in accordance with an example embodiment.

FIG. 4 illustrates a table in which skill level values are stored in association with skills of users of an online service, in accordance with an example embodiment.

FIG. 5 illustrates a GUI in which user interface elements that identify profiles of users are displayed, in accordance with an example embodiment.

FIG. 6 illustrates a GUI in which an online job posting is displayed, in accordance with an example embodiment.

FIG. 7 illustrates a GUI in which selectable user interface elements for online courses are displayed, in accordance with an example embodiment.

FIG. 8 illustrates a GUI in which a user may add a skill level to a profile of the user, in accordance with an example embodiment.

FIG. 9 is a block diagram illustrating a software architecture, in accordance with an example embodiment.

FIG. 10 illustrates a diagrammatic representation of a machine in the form of a computer system within which a set of instructions may be executed for causing the machine to perform any one or more of the methodologies discussed herein, in accordance with an example embodiment.

### DETAILED DESCRIPTION

### I. Overview

Example methods and systems of securely computing skill level of users of an online service using data anonymization to protect data privacy are disclosed. In the following description, for purposes of explanation, numerous specific details are set forth in order to provide a thorough understanding of example embodiments. It will be evident, however, to one skilled in the art that the present embodiments may be practiced without these specific details.

The above-discussed technical problems of accuracy are addressed by one or more example embodiments disclosed herein, in which a specially-configured computer system is configured to infer a user's skill level in a skill by leveraging user profiles, anonymized resumes, skill proficiency scores, and title-skill similarity scores to derive a novel title-skill association score that connects a duration (e.g., number of years) of experience a user has in a given job title (e.g., software engineer) to a duration of experience the user has in a skill that is associated with that job title (e.g., java). Duration of experience in the given job title is then used as a proxy to reflect skill level and title-skill association scores are used to reflect the level of confidence in the inferences. For example, if a user has 5 years of experience in a position with the job title “software engineer” and a skill “java” included in their profile, the computer system may compute a new title-skill association score that indicates how closely related “software engineer” is to “java” and use this score to reflect the level of confidence that the user's skill level in skill “java” corresponds to 5 years of experience.

In some example embodiments, the computer system of the present disclosure scans a plurality of reference user profiles to identify pairings of a job title and a skill that are both included in the same reference user profile, referred to herein as title-skill pairs. For each one of these title-skill pairs, the computer system may then obtain three scores: (1) a resume skill score that comprises a quantitative measurement of a likelihood that the reference user, from whose reference user profile the corresponding title-skill pair was extracted, has the skill of the corresponding title-skill pair, (2) a skill proficiency score that comprises a quantitative measurement of a proficiency, of the reference user from whose reference user profile the corresponding title-skill pair was extracted, in the skill of the title-skill pair, and (3) a title-skill similarity score that comprises a quantitative measurement of similarity between an embedding vector of the title of the corresponding title-skill pair and an embedding vector of the skill of the corresponding title-skill pair. In some example embodiments, the computer system uses these three scores to generate a dataset from the title-skill pairs, including in the dataset only the title-skill pairs that have a resume skill score, a skill proficiency score, and a title-skill similarity score that satisfy a dataset threshold value, and excluding from the dataset any title-skill pairs that do not have a resume skill score, a skill proficiency score, and a title-skill similarity score that satisfy the dataset threshold value. In this way, the computer system uses the resume skill score, the skill proficiency score, and the title-skill similarity score to reduce the reduce the number of title-skill pairs in the dataset in order avoid an excessive computational burden from the subsequent computations for the dataset.

In some example embodiments, for each of the title-skill pairs in the dataset, the computer system computes a title-skill association resume score based on a total number of users of an online service who have both the job title of the title-skill pair included in their user profile and the skill of the title-skill pair included in their resume and on a total number of users of the online service who have the skill of the title-skill pair included in their resume. Subsequently, the computer system may compute a combined skill-title association score for each title-skill pair in the dataset based on the title-skill association resume score of the title-skill pair and the title-skill similarity score of the title-skill pair. The combined skill-title association score indicates how closely the relationship is between the title and the skill. In some example embodiments, the computer system uses the combined skill-title association score as a measure of confidence of whether an amount of time-based experience that a user has had in the job title of the title-skill pair corresponds to an amount of time-based experience that the user has had in the skill of the title-skill pair. may then be used by the computer system to compute a skill level value

As mentioned above, one of the data sources used in computing the title-skill association score is user resumes. The user resumes may be stored and managed by an applicant tracking system. Although applicant tracking systems may be integrated with other online services, there may be restrictions on how the other online services may use data from the user resumes stored and managed by applicant tracking systems, since the user resumes sometimes contain private information about the users and the applicant tracking systems may obtain the resume data under conditions that limit the use of the resume data by the other online services. Therefore, a data privacy problem arises in using this data source. In order to address this technical problem, the computer system of the present disclosure performs a data anonymization process to remove identifying information from the resume data obtained from the user resumes.

In some example embodiments, the computer system, for each reference user profile in a plurality of reference user profiles stored in a database of an online service, extracts a title-skill pair from the reference user profile. The title-skill pair comprises a job title and a skill that are both included in the reference user profile. Each one of the plurality of reference user profiles belongs to a reference user having a user identification that is used by the online service to identify the reference user. The computer system also, for each one of the title-skill pairs extracted from the plurality of reference user profiles, obtains a resume skill score that is based on a resume of the reference user that corresponds to the reference user profile from which the title-skill pair was extracted. The resume skill score comprises a quantitative measurement of a likelihood that the reference user has the skill of the title-skill pair. Additionally, for each one of the title-skill pairs extracted from the plurality of reference user profiles, the computer system obtains a skill proficiency score that is based on the reference user profile from which the title-skill pair was extracted. The skill proficiency score comprises a quantitative measurement of a proficiency in the skill of the title-skill pair. The computer system also, for each one of the title-skill pairs extracted from the plurality of reference user profiles, obtains a title-skill similarity score comprising a quantitative measurement of similarity between an embedding vector of the title of the title-skill pair and an embedding vector of the skill of the title-skill pair.

Resume data offers a good source of information about a user's skills, since users who send their resumes to recruiters use mainly the most relevant and current skills on their resumes, whereas the skills extracted from user profiles may not offer as much confidence in their relevance. Even when using a title-skill similarity score and a skill proficiency score for a skill extracted from a user's profile, there is still a significant degree of uncertainty regarding whether the user actually uses the skill in their job. Leveraging resume data provides much greater confidence that the user has the skill and that the skill is current. The confidence is captured via the number of users with that title who also have that skill compared to the total number of users who have that skill on their resume. Namely, if Java appears mostly in resumes of software engineers, then the title-skill pair software engineer-Java is closely tied. Additionally, incorporating the use of a title-similarity score further increases the confidence in the closeness between the title-skill pair so that the aggregated skill-title association score can be used to map from years of experience in the job title to years of experience in the skill. The features of the present disclosure enable the computer system to leverage user resume data as an additional critical piece of information, while protecting data privacy.

In some example embodiments, the computer system generates a dataset including the title-skill pairs and the reference user identifications corresponding to the reference user profiles from which the title-skill pairs were extracted. The generating of the dataset comprises including the title-skill pairs in the dataset based on the resume skill scores of the title-skill pairs, the skill proficiency scores for the skills of the title-skill pairs, the title-skill similarity scores of the title-skill pairs, and at least one dataset threshold value. Next, for each one of the title-skill pairs in the dataset, the computer system computes a title-skill association resume score based on a total number of users of the online service who have the job title of the title-skill pair included in their user profile stored in the database of the online service and the skill of the title-skill pair included in their resume stored in the database of the online service and on a total number of users of the online service who have the skill of the title-skill pair included in their resume stored in the database of the online service.

The number of potential title-skill pairs to be processed by the computer system can get into the billions, creating a heavy workload for and slowing down the computer system. Therefore, in some example embodiments, in order to address this technical problem, the computer system limits the title-skill pairs based on a frequency level at which the titles and skills of the title-skill pairs are included in search queries submitted to the online service, such as search queries submitted by recruiters searching for candidates for jobs and users searching for jobs.

Next, the computer system performs a data anonymization process on the dataset. The data anonymization process comprises removing the reference user identifications from the dataset. Subsequent to the performing of the data anonymization process, the computer system computes a combined skill-title association score for each title-skill pair in the dataset based on the title-skill association resume score of the title-skill pair and the title-skill similarity score of the title-skill pair.

In some example embodiments, the computer system computes a skill level value of a first target user in response to a determination that a target user profile of the first target user stored in the database of the online service includes the job title and the skill of one of the title-skill pairs. The skill level value indicates a skill level of the first target user in the skill and is computed using a duration of experience of the first target user in the job title and the combined skill-title association score for the job title. The computer system then uses the skill level value in an application of the online service.

The term “reference” is used herein to indicate data and entities being used or involved in determining a combined skill-title association score, while the term “target” is used herein to indicate data and entities being used or involved in the use of the title-skill pair to determine a skill level value.

### II. Detailed Example Embodiments

The methods or embodiments disclosed herein may be implemented as a computer system having one or more components implemented in hardware or software. For example, the methods or embodiments disclosed herein may be embodied as instructions stored on a machine-readable medium that, when executed by one or more hardware processors, cause the one or more hardware processors to perform the instructions.

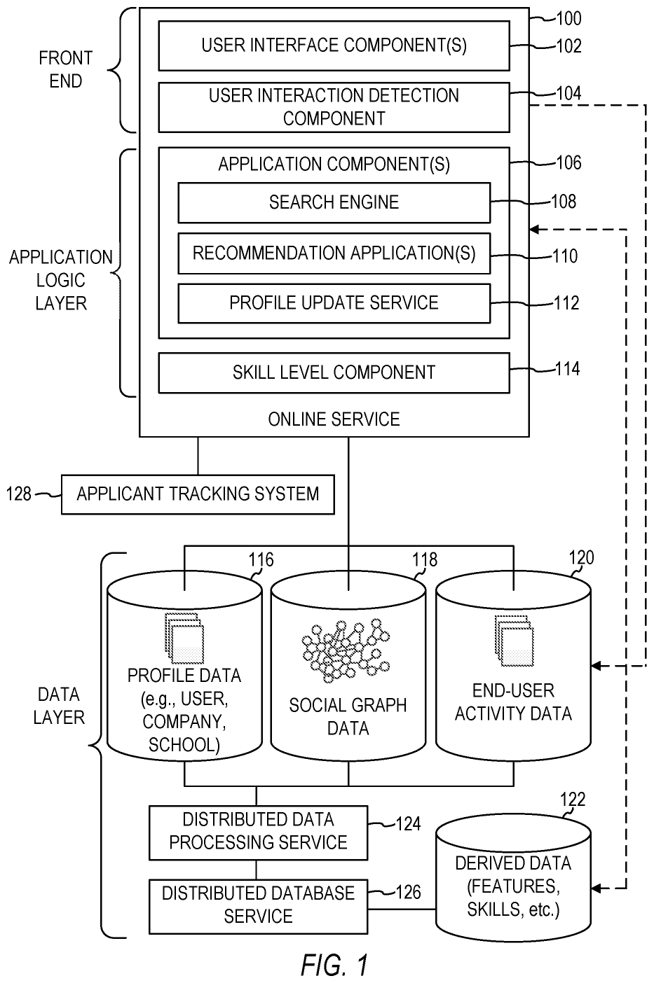

FIG. 1 is a block diagram illustrating functional components of an online service 100, in accordance with an example embodiment. As shown in FIG. 1, a front end may comprise one or more user interface components (e.g., a web server) 102, which receives requests from various client computing devices and communicates appropriate responses to the requesting client devices. For example, the user interface component(s) 102 may receive requests in the form of Hypertext Transfer Protocol (HTTP) requests or other web-based API requests. In addition, a user interaction detection component 104, sometimes referred to as a click tracking service, may be provided to detect various interactions that end-users have with different applications and services, such as those included in the application logic layer of the online service 100. As shown in FIG. 1, upon detecting a particular interaction, the user interaction detection component 104 logs the interaction, including the type of interaction and any metadata relating to the interaction, in an end-user activity database 120. Accordingly, data from this database 120 can be further processed to generate data appropriate for training one or more machine-learned models, and in particular, for training models to rank a set of skills for an end-user.

An application logic layer may include one or more application server components 106, which, in conjunction with the user interface component(s) 102, generate various user interfaces (e.g., web pages) with data retrieved from various data sources in a data layer. Consistent with some embodiments, individual application server components 106 implement the functionality associated with various applications and/or services provided by the online service 100. For instance, as illustrated in FIG. 1, the application logic layer includes a variety of applications and services to include a search engine 108, one or more recommendation applications 110 (e.g., a job recommendation application, an online course recommendation application), and a profile update service 112. The various applications and services illustrated as part of the application logic layer are provided as examples and are not meant to be an exhaustive listing of all applications and services that may be integrated with and provided as part of the online service 100. For example, although not shown in FIG. 1, the online service 100 may also include a job hosting service via which end-users submit job postings that can be searched by end-users, and/or recommended to other end-users by the recommendation application(s) 110. As end-user's interact with the various user interfaces and content items presented by these applications and services, the user interaction detection component 104 detects and tracks the end-user interactions, logging relevant information for subsequent use.

As shown in FIG. 1, the data layer may include several databases, such as a profile database 116 for storing profile data, including both end-user profile data and profile data for various organizations (e.g., companies, schools, etc.). Consistent with some embodiments, when a person initially registers to become an end-user of the online service, the person will be prompted by the profile update service 112 to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 116. Similarly, when a representative of an organization initially registers the organization with the online service 100, the representative may be prompted to provide certain information about the organization. This information may be stored, for example, in the profile database 116, or another database (not shown).

Once registered, an end-user may invite other end-users, or be invited by other end-users, to connect via the online service 100. A “connection” may constitute a bilateral agreement by the end-users, such that both end-users acknowledge the establishment of the connection. Similarly, with some embodiments, an end-user may elect to “follow” another end-user. In contrast to establishing a connection, the concept of “following” another end-user typically is a unilateral operation and, at least with some embodiments, does not require acknowledgement or approval by the end-user that is being followed. When one end-user follows another, the end-user may receive status updates relating to the other end-user, or other content items published or shared by the other end-user user who is being followed. Similarly, when an end-user follows an organization, the end-user becomes eligible to receive status updates relating to the organization as well as content items published by, or on behalf of, the organization. For instance, content items published on behalf of an organization that an end-user is following will appear in the end-user's personalized feed, sometimes referred to as a content feed or news feed. In any case, the various associations and relationships that the end-users establish with other end-users, or with other entities (e.g., companies, schools, organization) and objects (e.g., metadata hashtags (“#topic”) used to tag content items), are stored and maintained within a social graph in a social graph database 118.

As end-users interact with the various content items that are presented via the applications and services of the online service 100, the end-users' interactions and behaviors (e.g., content viewed, links or buttons selected, messages responded to, job postings viewed, etc.) are tracked by the user interaction detection component 104, and information concerning this activity of end-users may be logged or stored, for example, as indicated in FIG. 1 by the end-user activity database 120.

Consistent with some embodiments, data stored in the various databases of the data layer may be accessed by one or more software agents or applications executing as part of a distributed data processing service 124, which may process the data to generate derived data. The distributed data processing service 124 may be implemented using Apache Hadoop® or some other software framework for the processing of extremely large data sets. Accordingly, an end-user's profile data and any other data from the data layer may be processed (e.g., in the background or offline) by the distributed data processing service 124 to generate various derived profile data. As an example, if an end-user has provided information about various job titles that the end-user has held with the same organization or different organizations, and for how long, this profile information can be used to infer or derive an end-user profile attribute indicating the end-user's overall seniority level or seniority level within a particular organization. This derived data may be stored as part of the end-user's profile or may be written to another database.

In addition to generating derived attributes for end-users' profiles, one or more software agents or applications executing as part of the distributed data processing service 124 may ingest and process data from the data layer for the purpose of generating training data for use in training various machine-learned models, and for use in generating features for use as input to the trained models. For instance, profile data, social graph data, and end-user activity and behavior data, as stored in the databases of the data layer, may be ingested by the distributed data processing service 124 and processed to generate data properly formatted for use as training data for training one of the aforementioned machine-learned models for ranking skills. Similarly, the data may be processed for the purpose of generating features for use as input to the machine-learned models when ranking skills for a particular end-user. Once the derived data and features are generated, they are stored in a database 122, where such data can easily be accessed via calls to a distributed database service 124.

In some example embodiments, an applicant tracking system 128 is integrated into, or otherwise used by, the online service 100. The applicant tracking system 128 may comprise a software application that enables the electronic handling of recruitment and hiring needs. The applicant tracking system 128 may work like a resume database to help companies or other entities streamline their hiring process and review applications more quickly. In some example embodiments, the applicant tracking system 128 enables recruiters, or other users, to open new positions and post them online. Once the position is open, job candidates may apply for the open position, such as by submitting an application. All submitted applications may be stored in a database of the applicant tracking system 128. Then, recruiters can search submissions using keywords and phrases to identify candidates to advance through the hiring process. The applications may include resumes that are uploaded by the job candidates to the applicant tracking system 128 or resumes that are generated by the applicant tracking system 128 based on information entered by the job candidates. The online service 100 may communicate with the applicant tracking system 128 to determine which users of the online service 100 have a resume that is being stored and managed by the applicant tracking system 128, and also use this information to determine associations between resumes stored in the applicant tracking system 128 and user profiles stored in the database 116, such as which resume stored in the applicant tracking system 128 corresponds to which user profile stored in the database 116 based on a matching user identification between the resume and the user profile.

In some example embodiments, the application logic layer of the online service 100 also comprises a skill level component 114 that is configured to securely compute skill level of users of the online service 100 using data anonymization to protect data privacy. The skill level component 114 may infer a user's skill level in a skill by leveraging user profiles, anonymized resume data obtained from the applicant tracking system 128, skill proficiency scores, and title-skill similarity scores to derive a novel title-skill association score that connects a duration (e.g., number of years) of experience a user has in a given job title to a duration of experience the user has in a skill that is associated with that job title.

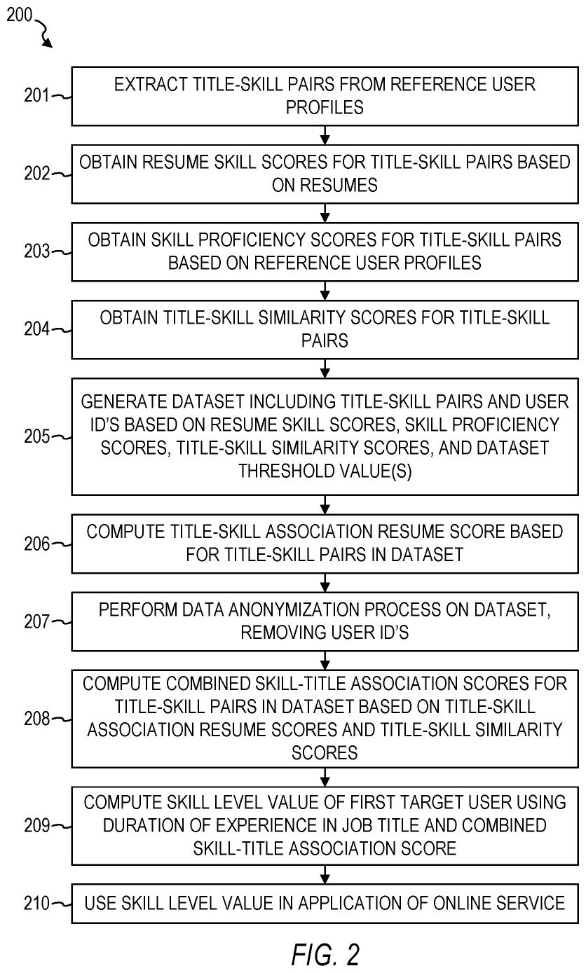

FIG. 2 a flowchart illustrating a method 200 of securely computing skill level of users of the online service 100 using data anonymization to protect data privacy, in accordance with an example embodiment. The method 200 can be performed by processing logic that can comprise hardware (e.g., circuitry, dedicated logic, programmable logic, microcode, etc.), software (e.g., instructions run on a processing device), or a combination thereof. In one implementation, the method 200 is performed by the online service 100 of FIG. 1, or any combination of one or more of its components (e.g., the skill level component 114, the application component 106).

At operation 201, skill level component 114, for each reference user profile in a plurality of reference user profiles stored in a database of the online service 100, extracts a title-skill pair from the reference user profile. The title-skill pair comprises a job title and a skill that are both included in the reference user profile. Each one of the plurality of reference user profiles belongs to a reference user having a user identification that is used by the online service 100 to identify the reference user.

For each reference user profile, the skill level component 114 may extract the explicit skills that are included in the reference user profile. Explicit skills are skills that were manually added by a user to their profile (e.g., member123, skill: java). The skill level component 114 may also extract the job titles for every position held by the user and the duration (e.g., years) of experience in the position with that job title (e.g., member123, title: software engineer, years of experience with title “software engineer”: 5 years).

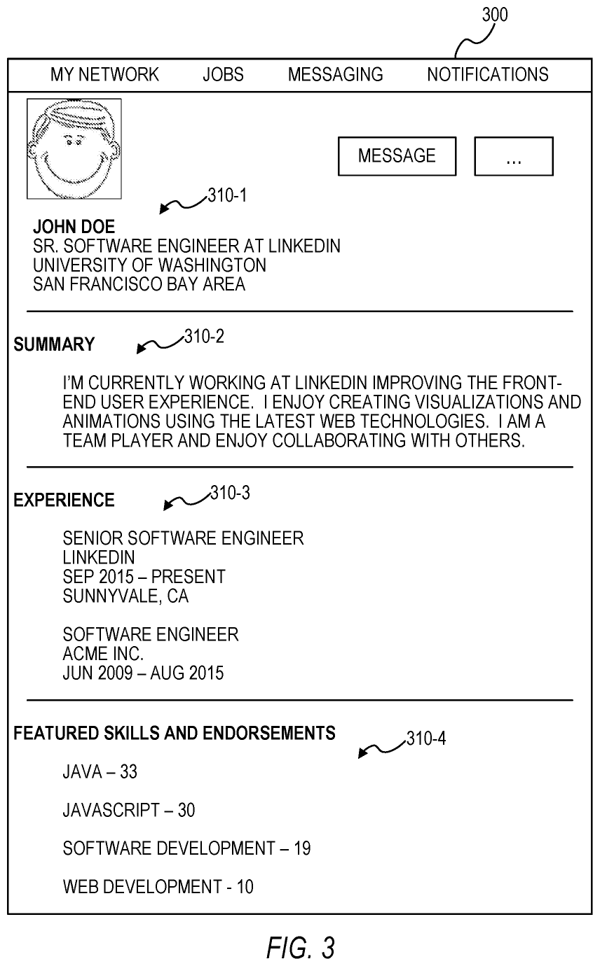

FIG. 3 illustrates a graphical user interface (GUI) 300 in which a user profile is displayed, in accordance with an example embodiment. The user profile displayed in the GUI 300 comprises profile data 310 of the user. In the example shown in FIG. 3, the profile data 310 includes headline data 310-1 identifying the user (e.g., photo and name), the user's current position at a particular organization, the user's current industry (not shown), and the user's current residential location, summary data 310-2, experience data 310-3, and featured skill and endorsement data 310-4 that identifies skills of the user along with a number of endorsements from other users for the skills of the user. The online service 100 may extract title-skill pairs from reference user profiles, such as from the user profile shown in FIG. 3. For example, the online service 100 may extract the following title-skill pairs from the user profile shown in FIG. 3: {(senior software engineer, java), (senior software engineer: javascript), (senior software engineer, software development), (senior software engineer, web development), (software engineer, java), (software engineer: javascript), (software engineer, software development), (software engineer, web development)}.

At operation 202, the skill level component 114, for each one of the title-skill pairs extracted from the plurality of reference user profiles, obtains a resume skill score that is based on a resume of the reference user that corresponds to the reference user profile from which the title-skill pair was extracted. The skill level component 114 may retrieve the resume skill score from the database 122. The resume skill score comprises a quantitative measurement of a likelihood that the reference user has the skill of the title-skill pair. For example, the skill level component 114 may obtain the resume skill scores {java: 0.99, python: 0.96}, thereby indicating a likelihood of 99% that the reference user has the skill of “java” and a likelihood of 96% that the reference user has the skill of “python.” In order to ensure high precision of resume-extracted skills, the skill level component 114 may take only the skills for which the confidence score is above a high threshold value, such as only the skill having a confidence score that is greater than 0.95.

In some example embodiments, the resume skill score is computed using a machine learning algorithm. For example, the skill level component 114 may use a natural language processing algorithm to compute the resume skill score. However, other types of machine learning algorithms are also within the scope of the present disclosure. In some example embodiments, the skill level component 114 retrieves, from the applicant tracking system 128, a resume of the reference user that corresponds to the reference user profile from which the title-skill pair was extracted, and then inputs features of the skill for which the resume skill score is being computed into a classifier. The skill may be a term that is extracted from the resume. One feature of the skill may comprise a context score that represents the probability (e.g., a value between 0 and 1) that the term is actually a valid skill based on contextual information of the term, such as the surrounding terms of the sentence from which the term was extracted. Another feature of the skill may comprise a skill-skill similarity score, which may be computed by computing a cosine similarity value between an embedding vector of the skill and an average of the embedding vectors of the skills listed in a section of the resume that is dedicated to skills (e.g., a dedicated skills section of the resume). The context score and the skill-skill similarity score may be input into the classifier, which may then produce a confidence score (e.g., a value between 0 and 1) that represents the likelihood that the user to which the resume belongs has the skill. This confidence score may be used by the skill level component 114 as the resume skill score.

At operation 203, the skill level component 114, for each one of the title-skill pairs extracted from the plurality of reference user profiles, obtains a skill proficiency score that is based on the reference user profile from which the title-skill pair was extracted. The skill proficiency score comprises a quantitative measurement of a proficiency in the skill of the title-skill pair. In some example embodiments, the skill proficiency score is computed based on a total number of endorsements for the skill of the title-skill pair in the reference user profile. When a user adds a skill to their profile, other users who are connected to the user may select a user interface element that is configured to register an endorsement of the skill for the user, thereby indicating a proficiency of the user in the skill. In some example embodiment, the skill proficiency score comprises a value between 0 and 1 (e.g., user123 has a skill proficiency score of 0.5 for the skill of Java and a skill proficiency score of 0.97 for the skill of Python). However, other metric scales may be used for the skill proficiency score as well.

At operation 204, the skill level component 114, for each one of the title-skill pairs extracted from the plurality of reference user profiles, obtains a title-skill similarity score comprising a quantitative measurement of similarity between an embedding vector of the title of the title-skill pair and an embedding vector of the skill of the title-skill pair. The title-skill similarity score comprises a quantitative measurement of how similar the title of the title-skill pair is to the skill of the title-skill pair. In some example embodiments, the skill level component 114 calculates the title-skill similarity score by calculating the cosine similarity between the embedding vector of the title of the title-skill pair and the embedding vector of the skill of the title-skill pair. However, the skill level component 114 may calculate the title-skill similarity score using other measures of similarity as well. In some example embodiments, the title-skill similarity score comprises a value between 0 and 1 (e.g., the title-skill similarity score for the job “software engineer” and the skill “java” may be 0.99, while the title-skill similarity score for the job “salesperson” and the skill “java” may be 0.28). However, other metric scales may be used for the title-skill similarity score as well.

The title-skill similarity scores may be computed by the skill level component 114 and stored in the database 122 prior to operation 204. The skill level component 114 may then retrieve the title-skill similarity scores from the database 122 at operation 204. In some embodiments in which the skill level component 114 computes the title-skill similarity scores prior to performing the obtaining step at operation 204, the skill level component 114 may compute the title-skill similarity scores for a pool of title-skill pairs that includes the title-skill pairs that are extracted at operation 201, but that also includes other title-skill pairs as well. However, in order to avoid excessive computation of every possible title-skill pair, the skill level component 114 may limit the calculation of the title-skill similarity scores to only a limited set of title-skill pairs. The skill level component 114 may determine which title-skill pairs for which to calculate the title-skill similarity score based on the co-occurrence of a given title and a given skill in bodies of text. Examples of bodies of text include, but are not limited to, online job postings and user profiles. For example, the skill level component 114 may scan online job postings and user profiles that are stored in one or more databases of the skill level component 114 to identify a title and a skill that occur in the same online job posting or in the same user profile, and then calculate the title-skill similarity score for each pairing of title and skill that co-occur in the same online job posting or in the same user profile.

At operation 205, the skill level component 114 generates a dataset including the title-skill pairs and the reference user identifications corresponding to the reference user profiles from which the title-skill pairs were extracted. The generating of the dataset comprises including the title-skill pairs in the dataset based on the resume skill scores of the title-skill pairs, the skill proficiency scores for the skills of the title-skill pairs, the title-skill similarity scores of the title-skill pairs, and at least one dataset threshold value. In some example embodiments, the at least one dataset threshold value comprises only a single threshold value, and the including the title-skill pairs in the dataset is based on a determination that the resume skill scores of the title-skill pairs, the skill proficiency scores for the skills of the title-skill pairs, and the title-skill similarity scores of the title-skill pairs all satisfy the single threshold value. For example, a single threshold value of 0.9 may be used for the resume skill scores of the title-skill pairs, the skill proficiency scores for the skills of the title-skill pairs, and the title-skill similarity scores of the title-skill pairs, such that the skill level component 114 only includes in the dataset those title-skill pairs that have a resume skill score that is equal to or greater than 0.9, a skill proficiency score that is equal to or greater than 0.9, and a title-skill similarity score that is equal to or greater than 0.9. Other dataset threshold values are also within the scope of the present disclosure. Furthermore, separate dataset threshold values may be used for the resume skill score, the skill proficiency score, and the title-skill similarity score. For example, the online service 100 may only include in the dataset those title-skill pairs that have a resume skill score that is equal to or greater than 0.9, a skill proficiency score that is equal to or greater than 0.8, and a title-skill similarity score that is equal to or greater than 0.85.

The generation of the dataset at operation 205 is important to the scalability of the skill level computation performed by the skill level component 114 in method 200. Without significantly reducing the number of title-skill pairs in the dataset, the processing of every available title-skill pair is extremely computationally expensive and would slow down the performance of the skill level component 114. Therefore, the use of one or more dataset threshold values at operation 205 helps overcome this technical problem by significantly reducing the number of title-skill pairs to be processed, thereby significantly reducing the computational expense involved in the skill level computation performed by the skill level component 114.

Additionally, if the skill level component 114 determines that the use of the one or more dataset threshold values has not sufficiently reduced the total number of title-skill pairs in the dataset (e.g., the total number of title-skill pairs is still above 25 million), then the skill level component 114 may further reduce the number of title-skill pairs in the dataset by restricting the dataset based on a frequency level at which the titles and skills of the title-skill pairs are included in search queries submitted to the online service 100. In some example embodiments, the skill level component 114 restricts the dataset to only a portion of the most frequently searched titles and skills. For example, the skill level component 114 may determine the top 5,000 most frequently searched titles within the last month and the 5,000 most frequently searched skills within the last month, and then limit the dataset to include only the title-skill pairs that have a title and a skill in those top 5,000 most frequently search titles and skills. The skill level component 114 may use recruiter search queries or job search queries or a combination thereof. Other types of search queries performed on the online service 100 may be used as well.

At operation 206, the skill level component 114, for each one of the title-skill pairs in the dataset, computes a title-skill association resume score based on a first value and a second value. The first value is equal to a total number of users of the online service 100 who have both the job title of the title-skill pair included in their user profile stored in the database of the online service 100 and the skill of the title-skill pair included in their resume stored in the applicant tracking system 128, and the second value is a total number of users of the online service 100 who have the skill of the title-skill pair included in their resume stored in the applicant tracking system 128. In some example embodiments, the computing the title-skill association resume score comprises dividing the first value by the second value, thereby dividing the total number of users of the online service 100 who have both the job title of the title-skill pair included in their user profile stored in the database of the online service 100 and the skill of the title-skill pair included in their resume stored in the database of the online service 100 by the total number of users of the online service 100 who have the skill of the title-skill pair included in their resume stored in the database of the online service 100, such as: (number of users with title t on their profile and skill s in their resume)/(number of users with skill s in their resume). The skill level component 114 may communicate with the applicant tracking system 128 to determine which users of the online service 100 have a resume that is being stored and managed by the applicant tracking system 128, as well as to access the stored resume data to determine the first value and the second value.

At operation 207, the skill level component 114 performs a data anonymization process on the dataset. Data anonymization is the process of protecting private or sensitive information by erasing or encrypting identifiers that connect an individual to stored data. In some example embodiments, the data anonymization process comprises removing the reference user identifications from the dataset. As a result of this data anonymization process, the skill level component 114 retains, for each title-skill pair in the dataset, only the title-skill similarity score and the title-skill association resume score, such as (title=software engineer, skill=java, title-skill similarity score=0.99, title-skill association resume score=0.7).

At operation 208, the skill level component 114, subsequent to the performing of the data anonymization process, computes a combined skill-title association score for each title-skill pair in the dataset based on the title-skill association resume score of the title-skill pair and the title-skill similarity score of the title-skill pair. The skill level component 114 may then store each computed combined skill-title association score in the database of the online service 100 in association with the corresponding title-skill pair for which it was computed. In some example embodiments, the computing the combined skill-title association score comprises computing an average value of the title-skill association resume score and the title-skill similarity score, such as:

combined skill-title association score=(title-skill association resume score+title-skill similarity score)/2. The skill level component 114 may compute the combined skill-title association score for each title-skill pair in the dataset using a weighted average of the title-skill association resume score of the title-skill pair and the title-skill similarity score of the title-skill pair. In some example embodiments, the skill level component 114 uses a machine learning algorithm to tune the weights of the title-skill association resume score and the title-skill similarity score in the computation of the combined skill-title association score.

At operation 209, the skill level component 114 computes a skill level value of a first target user in response to a determination that a target user profile of the first target user stored in the database of the online service 100 includes the job title and the skill of one of the title-skill pairs. For example, the skill level component 114 may scan through the target user profile of the first target user stored in the database 116 and detect the inclusion of the job title and skill of one of the title-skill pairs in the target user profile. In response to detecting the inclusion of the job title and skill in the target user profile, the skill level component 114 may compute the skill level value for the skill. The skill level value indicates a skill level of the first target user in the skill.

In some example embodiments, the skill level component 114 is configured to compute the skill level value of the first target user for the skill using a duration of experience of the first target user in the job title and the combined skill-title association score for the job title. In some example embodiments, the duration of experience comprises a number of years. However, other types of durations of experience are also within the scope of the present disclosure.

In some example embodiments, the skill level component 114 extracts, the target profile, each job title and corresponding duration of experience in the job title, as well as the skills that are explicitly included as skills in the target profile. The skill level component 114 may then obtain the corresponding combined skill-title association score for each permutation of job title and skill extracted from the target profile, thereby providing a corresponding combined skill-title association score for each title-skill pair extracted from the target profile. Then, for each title-skill pair extracted from the target profile, the skill level component 114 may compute the skill level value of the first target user in the skill of the title-skill pair using the corresponding combined skill-title association score for the title-skill pair.

In some example embodiments, the computing the skill level value comprises determining that the combined skill-title association score satisfies a threshold value, and then, based on the determination that the combined skill-title association score satisfies the threshold value, setting the skill level value equal to the duration of experience of the target user in the job title. In one example, the skill level component 114 uses a threshold value of 0.95 to process the following title-skill pairs and combined skill-title association scores: (skill=java, title=software engineer, years of experience=5, combined skill-title association score=0.98) and (skill=social media, title=software engineer, years of experience=5, combined skill-title association score=0.71). Since the combined skill-title association score of 0.98 for the title-skill pair of java-software engineer satisfies the 0.95 threshold value, the skill level component 114 may determine that the skill level value of the first target user in the skill of java is equal to the 5 years of experience that the first target user has in the job title of software engineer. In contrast, since the combined skill-title association score of 0.71 for the title-skill pair of social media-software engineer does not satisfy the 0.95 threshold value, the skill level component 114 may determine that it cannot reliably compute the skill level value of the first target user in the skill of social media.

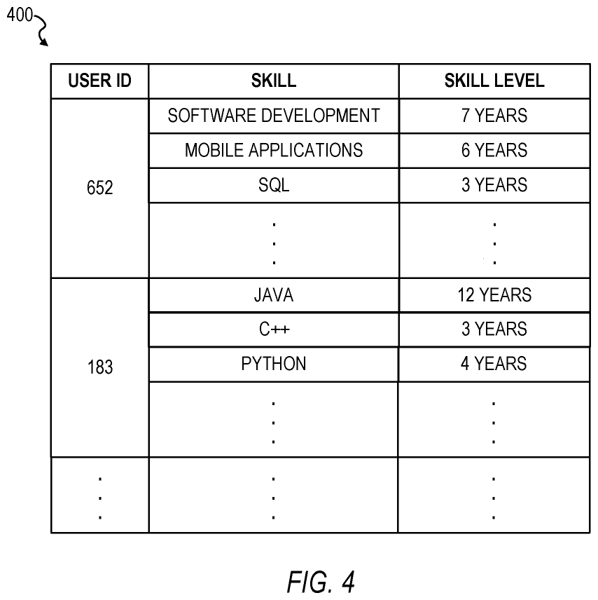

In some example embodiments, the skill level component 114 may store the computed skill level value in the target user profile of the first target user in association with the skill, thereby adding the computed skill level value to the target user profile. FIG. 4 illustrates a table 400 in which skill level values are stored in association with skills of users of an online service, in accordance with an example embodiment. For example, in the table 400, the user profile of user 652 includes a skill level value of 7 years for the skill of software development, a skill level value of 6 years for the skill of mobile applications, and a skill level value of 3 years for the skill of SQL, as well as other skill level values for other skills for user 652, and skill level values for the skills of other users (e.g., user 183).

At operation 210, the online service 100 uses the computed skill level value in an application of the online service. For example, the online service 100 may use the skill level value in one or more of the applications components 106, such as in the search engine 106, the recommendation application(s) 110, or the profile update service 112.

In some example embodiments, the using the skill level value in the application of the online service comprises receiving a search query submitted by a second target user via a computing device of the second target user, determining that the search query includes the skill of the one of the title-skill pairs, selecting the target user profile of the first target user based on the determination that the search query submitted by the second target user includes the skill of the one of the title-skill pairs and on the skill level value of the first target user, and then displaying, on a computing device of the second target user, a user interface element that identifies the target user profile of the first target user based on the selecting the target user profile of the first target user. This use of the skill level value may be implemented in a search for potential job candidates.

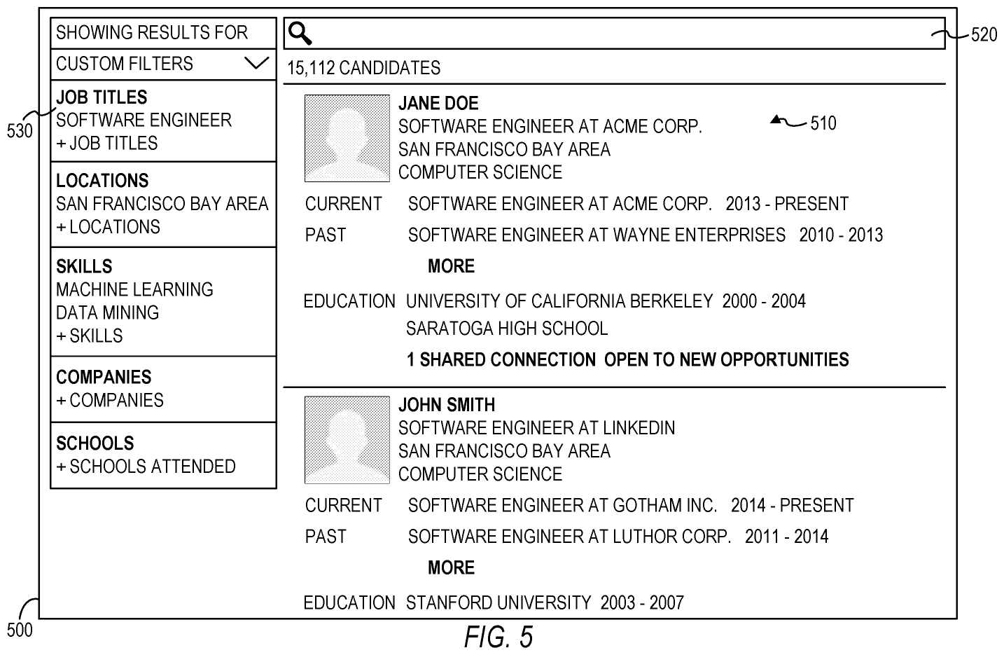

FIG. 5 illustrates a GUI 500 in which user interface elements that identify profiles of users are displayed, in accordance with an example embodiment. In some example embodiments, the search engine 108 is configured to select profiles of users that are potential job candidates based at least in part on a search query submitted by a user who is searching (referred to as a “searching user”) for potential job candidates, and to cause the selected profiles of the users to be displayed on a search results page of the GUI 500 to the searching user. In the GUI 500, the searching user (e.g., a recruiter) may submit one or more terms of a search query using one or more user interface elements. For example, the searching user may submit the term(s) by either entering text into a search field 520 or by using a custom search filters panel 530 via which the searching user may select and enter the terms based on the corresponding category of the terms (e.g., job titles, locations, skills, companies, schools). In response to the search query submitted by the searching user, the search engine 108 may cause user interface elements 510 that identify the selected profiles to be displayed on the search results page.

The search engine 108 may use computed skill levels of potential job candidates in selecting which user profiles to present as search results. For example, if the searching user includes the skill “java” in a search query, the search engine 108 may weight the user profiles based at least in part on the skill level value each user profile has for the skill “java,” thereby increasing the likelihood that a user profile will be selected for presentation the higher the skill level value of the user profile in the skill “java.”

In some example embodiments, the using the skill level value in the application of the online service comprises selecting a job posting from a plurality of job postings based a determination that the job posting includes the skill of the one of the title-skill pairs and on the skill level value of the first target user, and displaying, on a computing device of a first target user, the selected job posting as a search result for a search query submitted by the first target user via the computing device or as a recommendation.

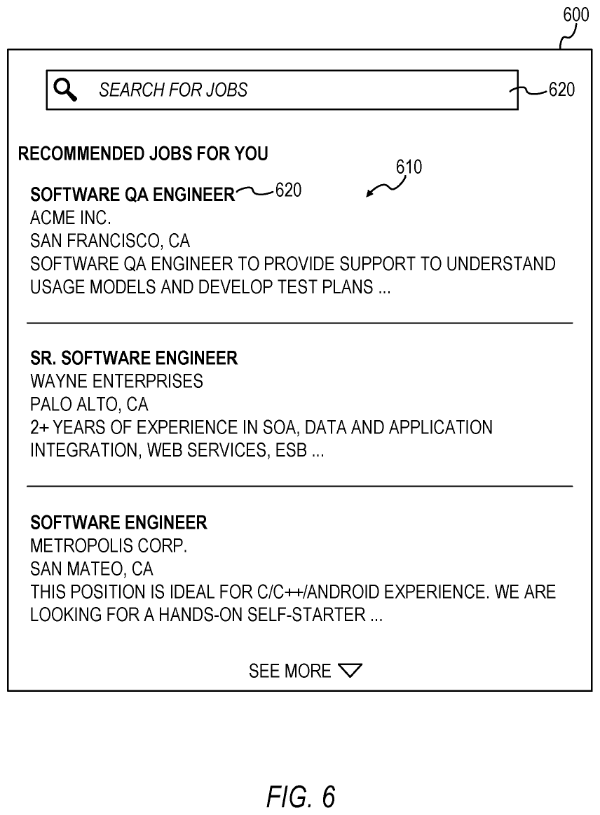

FIG. 6 illustrates a GUI 600 in which online job postings are displayed, in accordance with an example embodiment. In some example embodiments, the recommendation application 110 displays a corresponding selectable user interface element 620 in association with an indication 610 of the online job postings on a computing device of the first user. The recommendation application 110 may determine which online job postings to recommend to the first user based on a relevance scoring algorithm that calculates a relevance score for each online job posting indicating a level of relevance of the online job posting to the first user. The relevance scoring algorithm may incorporate the use of the skill level values of the first user, increasing the likelihood that an online job posting will be selected for recommendation to the first user if the online job posting is determined by the recommendation application 110 to be related to a skill for which the first user has a high skill level value. In other words, the higher the skill level value the first user has in a skill that is related to an online job posting, the higher the relevance score will be for the online job posting.

The corresponding selectable user interface element 620 may be configured to, in response to its selection, trigger a display of the online job posting on the computing device of the first user or initiate an online application process for the online job posting on the computing device of the first user. The GUI 600 may also include a search field 620 configured to receive a search query from the first user. In response to the search query, the search engine 108 may generate search results for the search query using the skill level values computed for user profiles, such as by using the relevance scoring algorithm discussed above.

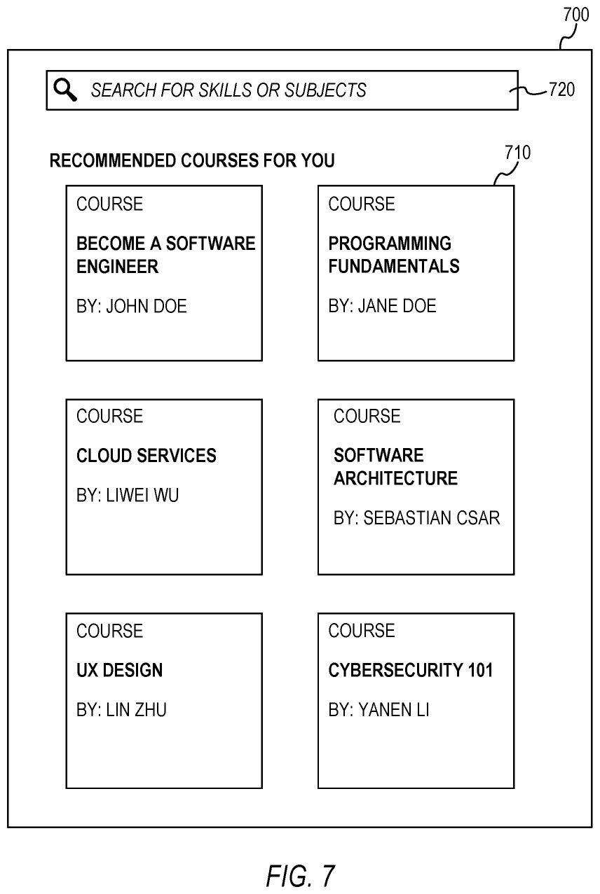

In some example embodiments, the using the skill level value in the application of the online service comprises selecting an online courses from a plurality online courses based a determination that the online course includes the skill of the one of the title-skill pairs and on the skill level value of the first target user, and then displaying, on a computing device of a first target user, the selected online course as a search result for a search query submitted by the first target user via the computing device or as a recommendation. FIG. 7 illustrates a GUI 700 in which online courses are displayed, in accordance with an example embodiment. The recommendation application 110 may, based on the skill level values of the first user, display a corresponding selectable user interface element 710 in association with an indication of the online course on a computing device of the first user. The recommendation application 110 may determine which online courses to recommend to the first user based on a relevance scoring algorithm that calculates a relevance score for each online course indicating a level of relevance of the online course to the first user. The relevance scoring algorithm may incorporate the use of the skill level values of the first user, increasing the likelihood that an online course will be selected for recommendation to the first user if the online course is determined by the recommendation application 110 to be related to a skill for which the first user has a high skill level value. In other words, the higher the skill level value the first user has in a skill that is related to an online course, the higher the relevance score will be for the online course.

The corresponding selectable user interface element 710 may be configured to, in response to its selection, trigger an online process for playing the online course on the computing device of the first user. The GUI 700 may also include a search field 720 configured to receive a search query from the first user. In response to the search query, the search engine 108 may generate search results for the search query using the skill level values of the first user, such as by using the relevance scoring algorithm discussed above.

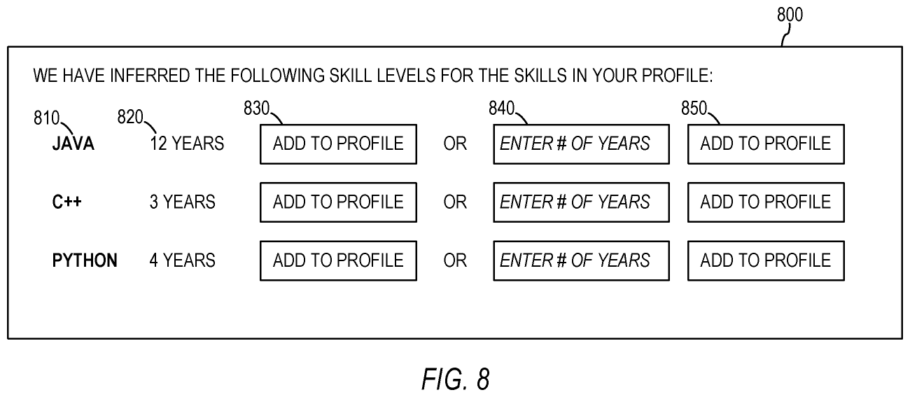

In some example embodiments, the using the skill level value in the application of the online service comprises displaying one or more recommendations to add a computed skill level value to the user profile of the first target user. For example, the profile update service 112 may display, on a computing device of the first target user, a selectable user interface element in association with the skill level value and the skill of the one of the title-skill pairs. In some example embodiment, the selectable user interface element is configured to trigger storing of the skill level value in association with the skill of the one of the title-skill pairs as part of the target user profile of the first target user in response to a selection of the selectable user interface element. FIG. 8 illustrates a GUI 800 in which a user may add a skill level to a profile of the user, in accordance with an example embodiment. In FIG. 8, the GUI 800 displays a selectable user interface element 830 in association with the corresponding skill level value 820 and skill 810 of title-skill pairs. In some example embodiment, the selectable user interface element 830 is configured to trigger storing of the skill level value 820 in association with the skill 810 as part of the target user profile of the first target user in response to a selection of the selectable user interface element 830.

In some example embodiments, the GUI 800 also includes user interface elements 840 and 850 that are configured to enable the first target user to update the target user profile with a different skill level value than the computed skill level value 820. For example, in FIG. 8, instead of the first target user adding the recommended “12 years” as the skill level value for the skill of “Java” in the target user profile of the first target user, the first target user may enter a different skill level value into the user interface element 840 and then select the user interface element 850, thereby triggering the storing of the user-entered skill level value in association with the skill 810 as part of the target user profile of the first target user. The online service 100 may use this manual correction of the skill level value by the first target user as training data to train and modify the skill level component's computation of the skill level value. For example, the skill level component may be reconfigured, based on such training data, to compute the skill level value as being 10% lower than the years of experience rather than making the skill level value equal to years of experience.

It is contemplated that any of the other features described within the present disclosure can be incorporated into the method 200.

Certain embodiments are described herein as including logic or a number of components or mechanisms. Components may constitute either software components (e.g., code embodied (1) on a non-transitory machine-readable medium or (2) in a transmission signal) or hardware-implemented components. A hardware-implemented component is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented component that operates to perform certain operations as described herein.

In various embodiments, a hardware-implemented component may be implemented mechanically or electronically. For example, a hardware-implemented component may comprise dedicated circuitry or logic that is permanently configured (e.g., as a special-purpose processor, such as a field programmable gate array (FPGA) or an application-specific integrated circuit (ASIC)) to perform certain operations. A hardware-implemented component may also comprise programmable logic or circuitry (e.g., as encompassed within a programmable processor) that is temporarily configured by software to perform certain operations. It will be appreciated that the decision to implement a hardware-implemented component mechanically, in dedicated and permanently configured circuitry, or in temporarily configured circuitry (e.g., configured by software) may be driven by cost and time considerations.

Accordingly, the term “hardware-implemented component” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented components are temporarily configured (e.g., programmed), each of the hardware-implemented components need not be configured or instantiated at any one instance in time. For example, where the hardware-implemented components comprise a processor configured using software, the processor may be configured as respective different hardware-implemented components at different times. Software may accordingly configure a processor, for example, to constitute a particular hardware-implemented component at one instance of time and to constitute a different hardware-implemented component at a different instance of time.

Hardware-implemented components can provide information to, and receive information from, other hardware-implemented components. Accordingly, the described hardware-implemented components may be regarded as being communicatively coupled. Where multiple of such hardware-implemented components exist contemporaneously, communications may be achieved through signal transmission (e.g., over appropriate circuits and buses) that connect the hardware-implemented components. In embodiments in which multiple hardware-implemented components are configured or instantiated at different times, communications between such hardware-implemented components may be achieved, for example, through the storage and retrieval of information in memory structures to which the multiple hardware-implemented components have access. For example, one hardware-implemented component may perform an operation, and store the output of that operation in a memory device to which it is communicatively coupled. A further hardware-implemented component may then, at a later time, access the memory device to retrieve and process the stored output. Hardware-implemented components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Similarly, the methods described herein may be at least partially processor-implemented. For example, at least some of the operations of a method may be performed by one or more processors or processor-implemented components. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

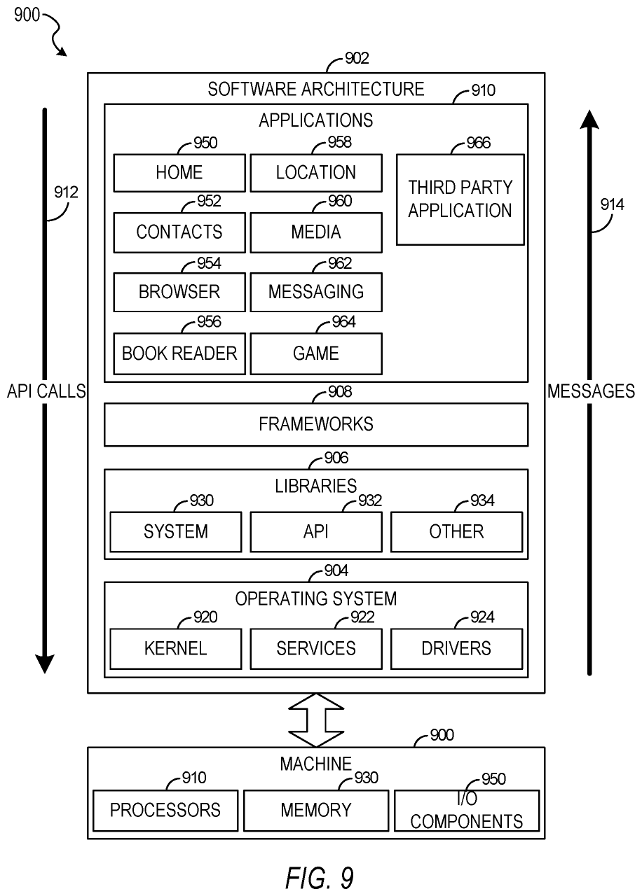

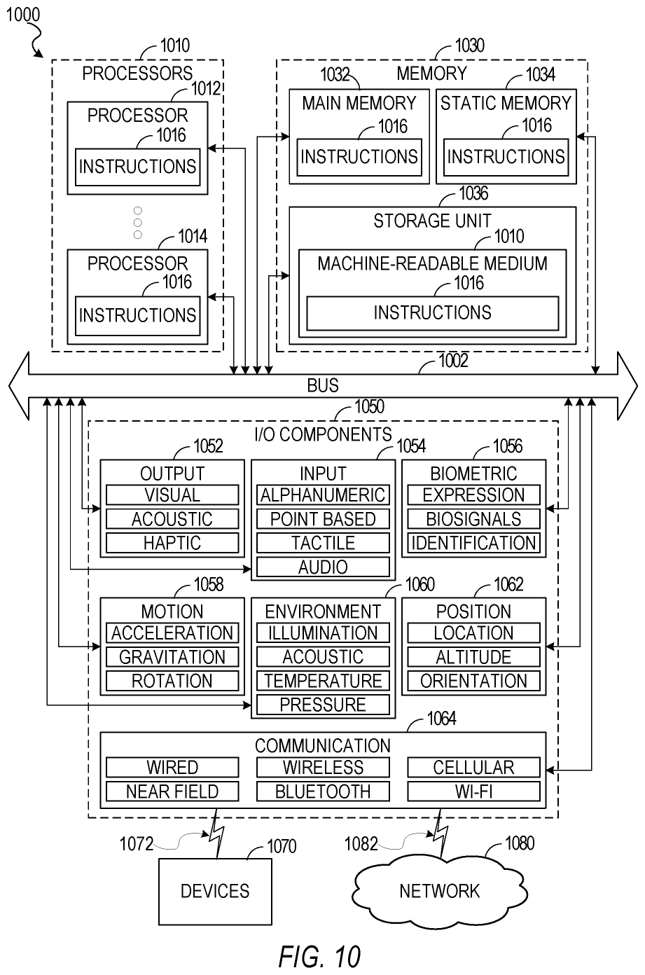

FIG. 9 is a block diagram 900 illustrating a software architecture 902, which can be installed on any one or more of the devices described above. FIG. 9 is merely a non-limiting example of a software architecture, and it will be appreciated that many other architectures can be implemented to facilitate the functionality described herein. In various embodiments, the software architecture 902 is implemented by hardware such as a machine 1000 of FIG. 10 that includes processors 910, memory 930, and input/output (I/O) components 950. In this example architecture, the software architecture 902 can be conceptualized as a stack of layers where each layer may provide a particular functionality. For example, the software architecture 902 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various GUI functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate functionality described herein.

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application 1010, an applet, an app, or other executable code) for causing the machine 1000 to perform any one or more of the methodologies discussed herein may be executed. For example, the instructions 1016 may cause the machine 1000 to execute the method 200 of FIG. 2. Additionally, or alternatively, the instructions 1016 may implement FIGS. 1-8, and so forth. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors 1012 (sometimes referred to as “cores”) that may execute instructions 1016 contemporaneously. Although FIG. 10 shows multiple processors 1010, the machine 1000 may include a single processor 1012 with a single core, a single processor 1012 with multiple cores (e.g., a multi-core processor), multiple processors 1010 with a single core, multiple processors 1010 with multiple cores, or any combination thereof.

The memory 1030 may include a main memory 1032, a static memory 1034, and a storage unit 1036, all accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine 1000 will depend on the type of machine 1000. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion, and the grouping is in no way limiting. In various example embodiments, the I/O components 1050 may include output components 1052 and input components 1054. The output components 1052 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

The various memories (i.e., 1030, 1032, 1034, and/or memory of the processor(s) 1010) and/or the storage unit 1036 may store one or more sets of instructions 1016 and data structures (e.g., software) embodying or utilized by any one or more of the methodologies or functions described herein. These instructions (e.g., the instructions 1016), when executed by the processor(s) 1010, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1016 and/or data. The terms shall accordingly be taken to include, but not be limited to, solid-state memories, and optical and magnetic media, including memory internal or external to the processors 1010. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1080 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method performed by a computer system having a memory and at least one hardware processor, the computer-implemented method comprising:
for each reference user profile in a plurality of reference user profiles stored in a database of an online service, extracting a title-skill pair from the reference user profile, the title-skill pair comprising a job title and a skill that are both included in the reference user profile, each one of the plurality of reference user profiles belonging to a reference user having a user identification that is used by the online service to identify the reference user;
for each one of the title-skill pairs extracted from the plurality of reference user profiles, obtaining a resume skill score that is based on a resume of the reference user that corresponds to the reference user profile from which the title-skill pair was extracted, the resume skill score comprising a quantitative measurement of a likelihood that the reference user has the skill of the title-skill pair;
for each one of the title-skill pairs extracted from the plurality of reference user profiles, obtaining a skill proficiency score that is based on the reference user profile from which the title-skill pair was extracted, the skill proficiency score comprising a quantitative measurement of a proficiency in the skill of the title-skill pair;
for each one of the title-skill pairs extracted from the plurality of reference user profiles, obtaining a title-skill similarity score comprising a quantitative measurement of similarity between an embedding vector of the title of the title-skill pair and an embedding vector of the skill of the title-skill pair;
generating a dataset including the title-skill pairs and the reference user identifications corresponding to the reference user profiles from which the title-skill pairs were extracted, the generating of the dataset comprising including the title-skill pairs in the dataset based on the resume skill scores of the title-skill pairs, the skill proficiency scores for the skills of the title-skill pairs, the title-skill similarity scores of the title-skill pairs, and at least one dataset threshold value;
for each one of the title-skill pairs in the dataset, computing a title-skill association resume score based on a total number of users of the online service who have the job title of the title-skill pair included in their user profile stored in the database of the online service and the skill of the title-skill pair included in their resume stored in the database of the online service and on a total number of users of the online service who have the skill of the title-skill pair included in their resume stored in the database of the online service;
performing a data anonymization process on the dataset, the data anonymization process comprising removing the reference user identifications from the dataset;
subsequent to the performing of the data anonymization process, computing a combined skill-title association score for each title-skill pair in the dataset based on the title-skill association resume score of the title-skill pair and the title-skill similarity score of the title-skill pair;
computing a skill level value of a first target user in response to a determination that a target user profile of the first target user stored in the database of the online service includes the job title and the skill of one of the title-skill pairs, the skill level value indicating a skill level of the first target user in the skill and being computed using a duration of experience of the first target user in the job title and the combined skill-title association score for the job title; and
using the skill level value in an application of the online service.

2. The computer-implemented method of claim 1, wherein the resume skill score is computed using a machine learning algorithm.

3. The computer-implemented method of claim 1, wherein the skill proficiency score is computed based on a total number of endorsements for the skill of the title-skill pair in the reference user profile.

4. The computer-implemented method of claim 1, wherein the at least one dataset threshold value comprises only a single threshold value, and the including the title-skill pairs in the dataset is based on a determination that the resume skill scores of the title-skill pairs, the skill proficiency scores for the skills of the title-skill pairs, and the title-skill similarity scores of the title-skill pairs all satisfy the single threshold value.

5. The computer-implemented method of claim 1, wherein the including the title-skill pairs in the dataset is further based on a frequency level at which the titles and skills of the title-skill pairs are included in search queries submitted to the online service.

6. The computer-implemented method of claim 1, wherein the computing the title-skill association resume score comprises dividing the total number of users of the online service who have the job title of the title-skill pair included in their user profile stored in the database of the online service and the skill of the title-skill pair included in their resume stored in the database of the online service by the total number of users of the online service who have the skill of the title-skill pair included in their resume stored in the database of the online service.

7. The computer-implemented method of claim 1, wherein the computing the combined skill-title association score comprises computing an average value of the title-skill association resume score and the title-skill similarity score.

8. The computer-implemented method of claim 1, wherein the computing the skill level value comprises:
determining that the combined skill-title association score satisfies a threshold value; and
based on the determination that the combined skill-title association score satisfies the threshold value, setting the skill level value equal to the duration of experience of the target user in the job title.

9. The computer-implemented method of claim 8, wherein the duration of experience comprises a number of years.

10. The computer-implemented method of claim 1, wherein the using the skill level value in the application of the online service comprises:
receiving a search query submitted by a second target user via a computing device of the second target user;
determining that the search query includes the skill of the one of the title-skill pairs;
selecting the target user profile of the first target user based on the determination that the search query submitted by the second target user includes the skill of the one of the title-skill pairs and on the skill level value of the first target user; and
displaying, on a computing device of the second target user, a user interface element that identifies the target user profile of the first target user based on the selecting the target user profile of the first target user.

11. The computer-implemented method of claim 1, wherein the using the skill level value in the application of the online service comprises:
selecting a job posting from a plurality of job postings based a determination that the job posting includes the skill of the one of the title-skill pairs and on the skill level value of the first target user; and
displaying, on a computing device of a first target user, the selected job posting as a search result for a search query submitted by the first target user via the computing device or as a recommendation.

12. The computer-implemented method of claim 1, wherein the using the skill level value in the application of the online service comprises:
selecting an online courses from a plurality online courses based a determination that the online course includes the skill of the one of the title-skill pairs and on the skill level value of the first target user; and
displaying, on a computing device of a first target user, the selected online course as a search result for a search query submitted by the first target user via the computing device or as a recommendation.

13. The computer-implemented method of claim 1, wherein the using the skill level value in the application of the online service comprises:
displaying, on a computing device of the first target user, a selectable user interface element in association with the skill level value and the skill of the one of the title-skill pairs, the selectable user interface element being configured to trigger storing of the skill level value in association with the skill of the one of the title-skill pairs as part of the target user profile of the first target user in response to a selection of the selectable user interface element.

14. A system comprising:
at least one hardware processor; and
a non-transitory machine-readable medium embodying a set of instructions that, when executed by the at least one hardware processor, cause the at least one hardware processor to perform operations, the operations comprising:
for each reference user profile in a plurality of reference user profiles stored in a database of an online service, extracting a title-skill pair from the reference user profile, the title-skill pair comprising a job title and a skill that are both included in the reference user profile, each one of the plurality of reference user profiles belonging to a reference user having a user identification that is used by the online service to identify the reference user;
for each one of the title-skill pairs extracted from the plurality of reference user profiles, obtaining a resume skill score that is based on a resume of the reference user that corresponds to the reference user profile from which the title-skill pair was extracted, the resume skill score comprising a quantitative measurement of a likelihood that the reference user has the skill of the title-skill pair;
for each one of the title-skill pairs extracted from the plurality of reference user profiles, obtaining a skill proficiency score that is based on the reference user profile from which the title-skill pair was extracted, the skill proficiency score comprising a quantitative measurement of a proficiency in the skill of the title-skill pair;
for each one of the title-skill pairs extracted from the plurality of reference user profiles, obtaining a title-skill similarity score comprising a quantitative measurement of similarity between an embedding vector of the title of the title-skill pair and an embedding vector of the skill of the title-skill pair;
generating a dataset including the title-skill pairs and the reference user identifications corresponding to the reference user profiles from which the title-skill pairs were extracted, the generating of the dataset comprising including the title-skill pairs in the dataset based on the resume skill scores of the title-skill pairs, the skill proficiency scores for the skills of the title-skill pairs, the title-skill similarity scores of the title-skill pairs, and at least one dataset threshold value;
for each one of the title-skill pairs in the dataset, computing a title-skill association resume score based on a total number of users of the online service who have the job title of the title-skill pair included in their user profile stored in the database of the online service and the skill of the title-skill pair included in their resume stored in the database of the online service and on a total number of users of the online service who have the skill of the title-skill pair included in their resume stored in the database of the online service;
performing a data anonymization process on the dataset, the data anonymization process comprising removing the reference user identifications from the dataset;
subsequent to the performing of the data anonymization process, computing a combined skill-title association score for each title-skill pair in the dataset based on the title-skill association resume score of the title-skill pair and the title-skill similarity score of the title-skill pair;
computing a skill level value of a first target user in response to a determination that a target user profile of the first target user stored in the database of the online service includes the job title and the skill of one of the title-skill pairs, the skill level value indicating a skill level of the first target user in the skill and being computed using a duration of experience of the first target user in the job title and the combined skill-title association score for the job title; and
using the skill level value in an application of the online service.

15. The system of claim 14, wherein the resume skill score is computed using a machine learning algorithm.

16. The system of claim 14, wherein the skill proficiency score is computed based on a total number of endorsements for the skill of the title-skill pair in the reference user profile.

17. The system of claim 14, wherein the at least one dataset threshold value comprises only a single threshold value, and the including the title-skill pairs in the dataset is based on a determination that the resume skill scores of the title-skill pairs, the skill proficiency scores for the skills of the title-skill pairs, and the title-skill similarity scores of the title-skill pairs all satisfy the single threshold value.

18. The system of claim 14, wherein the including the title-skill pairs in the dataset is further based on a frequency level at which the titles and skills of the title-skill pairs are included in search queries submitted to the online service.

19. The system of claim 14, wherein the computing the title-skill association resume score comprises dividing the total number of users of the online service who have the job title of the title-skill pair included in their user profile stored in the database of the online service and the skill of the title-skill pair included in their resume stored in the database of the online service by the total number of users of the online service who have the skill of the title-skill pair included in their resume stored in the database of the online service.

20. A non-transitory machine-readable medium embodying a set of instructions that, when executed by at least one hardware processor, cause the at least one hardware processor to perform operations, the operations comprising:
for each reference user profile in a plurality of reference user profiles stored in a database of an online service, extracting a title-skill pair from the reference user profile, the title-skill pair comprising a job title and a skill that are both included in the reference user profile, each one of the plurality of reference user profiles belonging to a reference user having a user identification that is used by the online service to identify the reference user;
for each one of the title-skill pairs extracted from the plurality of reference user profiles, obtaining a resume skill score that is based on a resume of the reference user that corresponds to the reference user profile from which the title-skill pair was extracted, the resume skill score comprising a quantitative measurement of a likelihood that the reference user has the skill of the title-skill pair;
for each one of the title-skill pairs extracted from the plurality of reference user profiles, obtaining a skill proficiency score that is based on the reference user profile from which the title-skill pair was extracted, the skill proficiency score comprising a quantitative measurement of a proficiency in the skill of the title-skill pair;
for each one of the title-skill pairs extracted from the plurality of reference user profiles, obtaining a title-skill similarity score comprising a quantitative measurement of similarity between an embedding vector of the title of the title-skill pair and an embedding vector of the skill of the title-skill pair;
generating a dataset including the title-skill pairs and the reference user identifications corresponding to the reference user profiles from which the title-skill pairs were extracted, the generating of the dataset comprising including the title-skill pairs in the dataset based on the resume skill scores of the title-skill pairs, the skill proficiency scores for the skills of the title-skill pairs, the title-skill similarity scores of the title-skill pairs, and at least one dataset threshold value;
for each one of the title-skill pairs in the dataset, computing a title-skill association resume score based on a total number of users of the online service who have the job title of the title-skill pair included in their user profile stored in the database of the online service and the skill of the title-skill pair included in their resume stored in the database of the online service and on a total number of users of the online service who have the skill of the title-skill pair included in their resume stored in the database of the online service;
performing a data anonymization process on the dataset, the data anonymization process comprising removing the reference user identifications from the dataset;
subsequent to the performing of the data anonymization process, computing a combined skill-title association score for each title-skill pair in the dataset based on the title-skill association resume score of the title-skill pair and the title-skill similarity score of the title-skill pair;
computing a skill level value of a first target user in response to a determination that a target user profile of the first target user stored in the database of the online service includes the job title and the skill of one of the title-skill pairs, the skill level value indicating a skill level of the first target user in the skill and being computed using a duration of experience of the first target user in the job title and the combined skill-title association score for the job title; and
using the skill level value in an application of the online service.
